(19) United States
(12) Patent Application Publication
(10) Pub. No.: US 2025/0278919 A1
(43) Pub. Date: Sep. 4, 2025

(54) SEGMENTATION MODEL TRAINING METHOD AND APPARATUS AND IMAGE RECOGNITION METHOD AND APPARATUS

(71) Applicant: Alipay (Hangzhou) Information Technology Co., Ltd., Hangzhou (CN)

(72) Inventors: Yongheng HU, Hangzhou (CN); Chenguang MA, Hangzhou (CN)

(21) Appl. No.: 18/858,198

(22) PCT Filed: Apr. 10, 2023
(86) PCT No.: PCT/CN2023/087270

§ 371 Date: Oct. 18, 2024

(30) Foreign Application Priority Data
Apr. 19, 2022 (CN) 202210407639.6

(51) Int. Cl. G06V 10/26; G06T 7/174; G06T 7/50; G06V 10/44; G06V 10/82

(52) U.S. Cl. CPC G06V 10/26; G06T 7/174; G06T 7/50; G06V 10/44; G06V 10/82; G06T 2207/10024; G06T 2207/10028; G06T 2207/20081; G06T 2207/20084; G06T 2207/20212

(57) ABSTRACT

Embodiments of this specification provide a segmentation model training method and apparatus, and an image recognition method and apparatus. The training method includes: obtaining a sample image pair, the sample image pair includes an RGB image and a depth image that are obtained by photographing the same visual range; inputting the depth image into the first network model, to obtain a first depth feature extraction result; inputting a combined image of the depth image and the RGB image into the second network model, to obtain an edge feature of a target object; inputting the edge feature of the target object and the first depth feature extraction result into the third network model, to obtain a segmentation result of the target object; performing a parameter adjustment on the first network model, the second network model, the third network model based on a label and the segmentation result of the target object.

### TECHNICAL FIELD

One or more embodiments of this specification relate to artificial intelligence technologies, and in particular, to a segmentation model training method and apparatus and an image recognition method and apparatus.

### BACKGROUND

Image recognition is a technology in which an image is processed, analyzed, and understood through a computer, to recognize target objects in various different modes. Image recognition technologies usually includes facial recognition and product recognition, etc. Facial recognition is mainly applied to a security check, identity verification, and mobile payment. Product recognition is mainly applied to a product circulation process, and especially, to the unmanned retail fields such as unmanned shelves and intelligent retail cabinets.

In the image recognition technologies, a target object needs to be recognized from various objects included in the image. For example, in a facial recognition solution, an interactive screen displays, in real time, data originally collected by a camera. However, in this process, in a queuing scenario, faces of persons who do not want the faces to be scanned also appear on the screen. Users who queue virtually feel unfriendliness to privacy. Some users even feel that privacy is violated. Therefore, through image recognition, a target face needs to be obtained through segmentation. For another example, in product recognition, a product that is previously paid for and a product that is currently to be paid for that are held by a user may exist in a photographed image. Therefore, through image recognition, the product that is currently to be paid for needs to be obtained through segmentation.

However, the target object cannot be obtained through segmentation in an image recognition method in a related technology.

### SUMMARY

One or more embodiments of this specification describe a segmentation model training method and apparatus and an image recognition method and apparatus, so that segmentation information of a target object in an image can be obtained more accurately.

According to a first aspect, a segmentation model training method is provided. The segmentation model includes a first network model, a second network model, and a third network model, and the method includes: obtaining a sample image pair, where the sample image pair includes an RGB image and a depth image that are obtained by photographing the same visual range; inputting the depth image into the first network model, to obtain a first depth feature extraction result output by the first network model; inputting a combined image of the depth image and the RGB image into the second network model, to obtain an edge feature that is of a target object and that is output by the second network model; inputting the edge feature of the target object and the first depth feature extraction result into the third network model, to obtain a segmentation result that is of the target object and that is output by the third network model; and performing a parameter adjustment on the first network model, the second network model, and the third network model based on a label of the sample image pair and the segmentation result of the target object.

The label of the sample image pair includes a first label and a second label, the first label is a segmentation result that is of the RGB image or the depth image and that is formed manually in advance, and the second label is obtained after Gaussian blur processing is performed on the first label; and the performing a parameter adjustment on the first network model, the second network model, and the third network model includes: performing a parameter adjustment on the second network model and the third network model based on a difference between the first label and the segmentation result of the target object; and performing a parameter adjustment on the first network model based on a difference between the second label and the first depth feature extraction result.

After the inputting the depth image into the first network model, the method further includes: obtaining contour information that is of the target object and that is extracted by an intermediate-layer neural network included in the first network model, and outputting, to the second network model as a second depth feature extraction result, the contour information that is of the target object and that is extracted by the intermediate-layer neural network; and after the inputting a combined image of the depth image and the RGB image into the second network model, and before the edge feature that is of the target object and that is output by the second network model is obtained, the method further includes: performing feature extraction on the combined image through each layer of front-end neural network included in the second network model, to obtain a primary edge feature; and processing the primary edge feature and the second depth feature extraction result though each layer of back-end neural network included in the second network model, to obtain and output the edge feature of the target object.

Convolution kernels and convolution strides of the first network model and the second network model are adjusted, so that the primary edge feature and the second depth feature extraction result correspond to the same image size.

Before the depth image and the RGB image are combined, the method further includes: normalizing a pixel value of the RGB image and a pixel value of the depth image, and normalizing, to 0, a pixel value of a pixel whose value is null in the depth image.

According to a second aspect, an image recognition method is provided, including: obtaining a to-be-processed RGB image and a to-be-processed depth image that are obtained by photographing the same visual range; inputting the to-be-processed depth image into a first network model, to obtain a depth feature extraction result output by the first network model; inputting a combined image of the to-be-processed depth image and the to-be-processed RGB image into a second network model, to obtain an edge feature that is of a target object and that is output by the second network model; and inputting the edge feature of the target object and the depth feature extraction result into a third network model, to obtain a segmentation result that is of the target object and that is output by the third network model.

According to a third aspect, a segmentation model training apparatus is provided, including: a sample image obtaining module, configured to obtain a sample image pair, where the sample image pair includes an RGB image and a depth image that are obtained by photographing the same visual range; a first network model training module, configured to input the depth image into a first network model, to obtain a first depth feature extraction result output by the first network model; a second network model training module, configured to: input a combined image of the depth image and the RGB image into a second network model, to obtain an edge feature that is of a target object and that is output by the second network model; a third network model training module, configured to input the edge feature of the target object and the first depth feature extraction result into a third network model, to obtain a segmentation result that is of the target object and that is output by the third network model; and an adjustment module, configured to perform a parameter adjustment on the first network model, the second network model, and the third network model based on a label of the sample image pair and the segmentation result of the target object.

The first network model training module is further configured to: obtain contour information that is of the target object and that is extracted by an intermediate-layer neural network included in the first network model, and output, to the second network model as a second depth feature extraction result, the contour information that is of the target object and that is extracted by the intermediate-layer neural network; and the second network model training module is further configured to: control each layer of front-end neural network included in the second network model to perform feature extraction on the combined image, to obtain a primary edge feature; and control each layer of back-end neural network included in the second network model to process the primary edge feature and the second depth feature extraction result, so that the second network model outputs the edge feature of the target object.

According to a fourth aspect, an image recognition apparatus is provided, including: an image input module, configured to obtain a to-be-processed RGB image and a to-be-processed depth image that are obtained by photographing the same visual range; a first network model, configured to receive the to-be-processed depth image, to obtain a depth feature extraction result; a second network model, configured to receive a combined image of the to-be-processed depth image and the to-be-processed RGB image, to obtain an edge feature of a target object; and a third network model, configured to receive the edge feature of the target object and the depth feature extraction result, to obtain a segmentation result of the target object.

According to a fifth aspect, a computing device is provided, including a memory and a processor. The memory stores executable code, and when the processor executes the executable code, the method according to any embodiment of this specification is implemented.

According to the segmentation model training method and apparatus, and the image recognition method and apparatus provided in the embodiments of this specification, not only the depth image is used at an initial stage of a training process (that is, the depth image and the RGB image are combined, to obtain the edge feature of the target object based on the combined image), but also the depth feature extraction result of the depth image is used at a subsequent stage of the training process. That is, the combined image and the depth feature extraction result are used together to train the segmentation model. It can be seen that depth information provided by the depth image is separately used at different stages of the training process, so that the trained segmentation model can more accurately obtain the segmentation information of the target object in the image.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show some embodiments of this specification, and a person of ordinary skill in the art can still derive other drawings from these accompanying drawings without creative efforts.

FIG. 1 is a schematic diagram illustrating a system architecture to which an embodiment of this specification is applied;

FIG. 2 is a flowchart illustrating a segmentation model training method, according to an embodiment of this specification;

FIG. 3A is a schematic diagram illustrating a training method for training a first segmentation model, according to an embodiment of this specification;

FIG. 3B is a schematic diagram illustrating an application structure of a first segmentation model, according to an embodiment of this specification;

FIG. 4A is a schematic diagram illustrating a training method for training a second segmentation model, according to an embodiment of this specification;

FIG. 4B is a schematic diagram illustrating an application structure of a second segmentation model, according to an embodiment of this specification;

FIG. 5 is a flowchart illustrating a method for training a segmentation model in Manner 2, according to an embodiment of this specification;

FIG. 6 is a flowchart illustrating an image recognition method, according to an embodiment of this specification;

FIG. 7 is a schematic structural diagram illustrating a segmentation model training apparatus, according to an embodiment of this specification; and

FIG. 8 is a schematic structural diagram illustrating an image recognition apparatus, according to an embodiment of this specification.

### DESCRIPTION OF EMBODIMENTS

As described above, a target object needs to be accurately obtained from an image through segmentation. For example, in a facial recognition process, a collected image includes information about two portraits, and information about a foremost and middle target portrait needs to be obtained through segmentation, to perform a service procedure such as facial recognition payment. For another example, in a product recognition process, a collected image includes information about three products, and information about a foremost and middle target product needs to be obtained through segmentation, to perform a service procedure such as paying the target product.

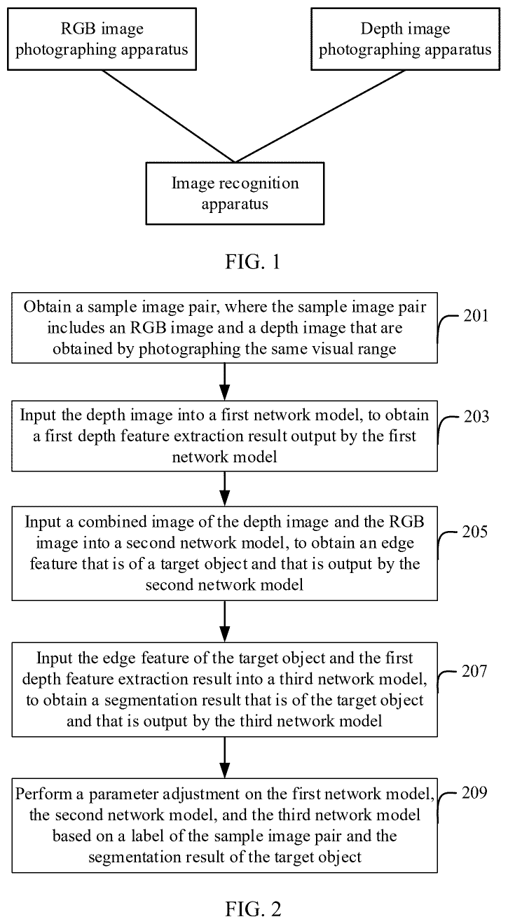

To facilitate understanding of the methods provided in this specification, a system architecture used in and applicable to this specification is first described. As shown in FIG. 1, the system architecture mainly includes an RGB image photographing apparatus, a depth image photographing apparatus, and an image recognition apparatus.

The RGB image photographing apparatus can photograph an RGB image, the depth image photographing apparatus can photograph a depth image, and the image recognition apparatus can perform foreground segmentation based on the RGB image and the depth image, to obtain information about a target object through segmentation. In actual applications, the RGB image photographing apparatus and the depth image photographing apparatus are usually disposed at the same location, to photograph the same visual range. Any one or more of the RGB image photographing apparatus, the depth image photographing apparatus, and the image recognition apparatus can be disposed in an independent device, or can be integrated into a POS machine (point of sale terminal) in a service scenario.

It should be understood that quantities of RGB image photographing apparatuses, depth image photographing apparatuses, and image recognition apparatuses in FIG. 1 are merely an example. Any quantity can be selected and arranged based on an actual implementation requirement.

In FIG. 1, the apparatuses interact with each other through a network. The network can include various connection types such as wired and wireless communication links, or fiber optic cables.

The method in the embodiments of this specification includes: A segmentation model is trained based on an RGB image and a depth image, and then, the segmentation model is disposed in an image recognition apparatus. In this way, in actual applications, the RGB image and the depth image that are to be segmented can be input into the segmentation model in the image recognition apparatus, to obtain segmentation information of a target object.

The following describes a segmentation model training method in the embodiments of this specification.

FIG. 2 is a flowchart illustrating a segmentation model training method, according to an embodiment of this specification. It may be understood that the method can be performed by any apparatus, device, platform, or device cluster having computing and processing capabilities. As shown in FIG. 2, in this embodiment of this specification, the segmentation model can be a joint model including a plurality of network models, and specifically includes a first network model, a second network model, and a third network model. The training method includes: Step 201: Obtain a sample image pair, where the sample image pair includes an RGB image and a depth image that are obtained by photographing the same visual range.

Step 203: Input the depth image into the first network model, to obtain a first depth feature extraction result output by the first network model.

Step 205: Input a combined image of the depth image and the RGB image into the second network model, to obtain an edge feature that is of a target object and that is output by the second network model.

Step 207: Input the edge feature of the target object and the first depth feature extraction result into the third network model, to obtain a segmentation result that is of the target object and that is output by the third network model.

Step 209: Perform a parameter adjustment on the first network model, the second network model, and the third network model based on a label of the sample image pair and the segmentation result of the target object.

It can be learned from the above-mentioned procedure shown in FIG. 2 that, the segmentation model needs to be trained, to obtain segmentation information of the target object in the image more accurately. When the segmentation model is trained, not only the RGB image is used, but also the depth image is used. A depth feature extraction result, namely, approximate contour information of the target object, can be obtained based on the depth image, and edge detail information can be obtained based on the RGB image. In this way, the depth image and the RGB image can be combined to supplement the edge detail information based on an approximate contour, to obtain more accurate segmentation information of the target object.

In addition, in the above-mentioned process shown in FIG. 2, not only the depth image is used at an initial stage of a training process (that is, the depth image and the RGB image are combined, to obtain an edge feature of the target object), but also the depth feature extraction result of the depth image is used at a subsequent stage of the training process. The first network model, the second network model, and the third network model are used, so that the combined image and the depth feature extraction result are used together to train the segmentation model. It can be seen that depth information provided by the depth image is separately used at different stages of the training process, so that the trained segmentation model can more accurately obtain the segmentation information of the target object in the image.

In this embodiment of this specification, as described above, the depth information provided by the depth image is separately used at different stages of the training process, and the different stages can include at least the following two types. In Manner 1, the different stages includes an initial stage and a final stage.

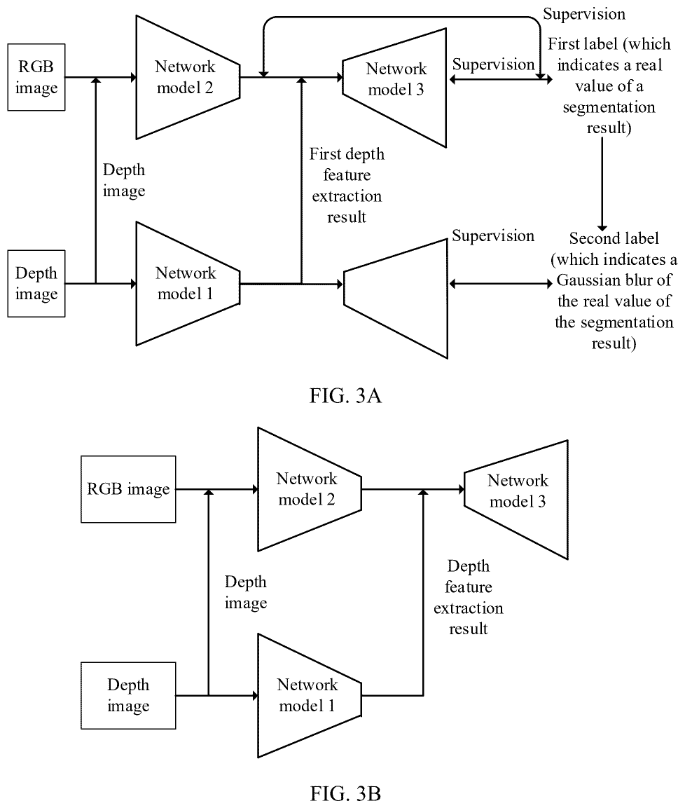

In Manner 1, the depth information provided by the depth image is used for two times in an initial stage and a last stage of a training process. Specifically, as shown in FIG. 3A, in the initial stage, the depth image and the RGB image that are photographed are input into a network model 2 after being combined. The depth information provided by the depth image is used for one time through the network model 2. Then, because the photographed depth image is further simultaneously input into a network model 1, the network model 1 outputs the first depth feature extraction result, and the first depth feature extraction result is input into a network model 3 together with an edge feature of a target object in an image finally output by the network model 2. The depth information provided by the depth image is used again through the network model 3.

In Manner 2, the different stages includes the initial stage, an intermediate stage, and a final stage.

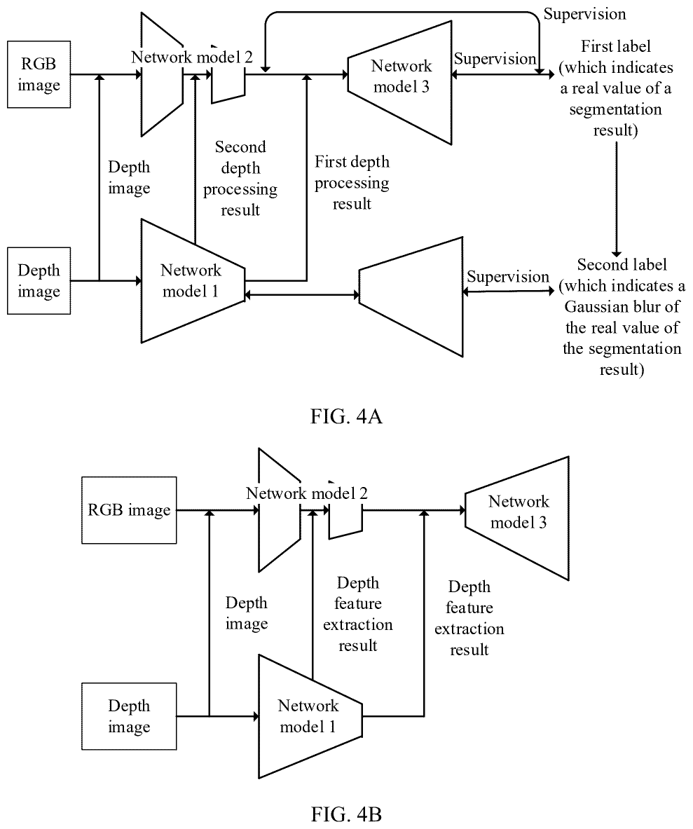

In Manner 2, the depth information provided by the depth image is used for three times in the initial stage, the intermediate stage, and the final stage of a training process. Specifically, as shown in FIG. 4A, in the initial stage, the depth image and the RGB image that are photographed are input into a network model 2 after being combined. The depth information provided by the depth image is used for one time through the network model 2. Then, the photographed depth image is further simultaneously input into a network model 1, and an intermediate-layer neural network of the network model 1 also obtains primary contour information of the target object. Although the primary contour information of the target object is not a final output of the network model 1, the contour information of the target object can reflect segmentation precision. Therefore, the contour information that is of the target object and that is extracted by the intermediate-layer neural network is provided to the network model 2 as a second depth feature extraction result (namely, an intermediate result of depth feature extraction), and the network model 2 performs processing based on the edge feature obtained based on the combined image and the second depth feature extraction result, to obtain a final output of the network model 2. It can be seen that the depth information provided by the depth image is used for the second time based on the second depth feature extraction result in an intermediate processing process of the network model 2. Finally, because the photographed depth image is further simultaneously input into the network model 1, the network model 1 outputs the first depth feature extraction result, and the first depth feature extraction result is input into a network model 3 together with an edge feature of a target object in an image finally output by the network model 2. The depth information provided by the depth image is used for the third time through the network model 3.

Regardless of whether Manner 1 or Manner 2 is used, in this embodiment of this specification, the network model 3 finally outputs the segmentation information of the target object, that is, obtains a final output result of the segmentation model. A parameter of the segmentation model can be adjusted based on the segmentation information and the label of the sample image pair, to implement training of the segmentation model.

The label of the sample image pair can include a first label and a second label, the first label is a segmentation result, namely, a real value of the segmentation result, that is of the RGB image or the depth image and that is formed manually in advance, and the second label is obtained after Gaussian blur processing is performed on the first label.

When a parameter adjustment is performed on the segmentation model, as shown in FIG. 3A and FIG. 4A, a parameter adjustment is performed on the network model 2 and the network model 3 based on a difference between the first label and the segmentation result of the target object; and a parameter adjustment is performed on the network model 1 based on a difference between the second label and the first depth feature extraction result.

It should be noted that, in the above-mentioned descriptions, a parameter adjustment is performed on the network model 2 based on the difference between the first label and the segmentation result of the target object. In another embodiment of this specification, an edge part of the first label, namely, the real value of the segmentation result, can be etched, to obtain a third label, and then the parameter adjustment is performed on the network model 2 based on a difference between the third label and the edge feature that is of the target object and that is output by the network model 2.

The training process is usually completed through a plurality of rounds of training, until the segmentation model converges. An application structure of a segmentation model trained in Manner 1, namely, a segmentation model subsequently applied to an image recognition service process is shown in FIG. 3B. An application structure of a segmentation model trained in Manner 2, namely, a segmentation model subsequently applied to an image recognition service process is shown in FIG. 4B.

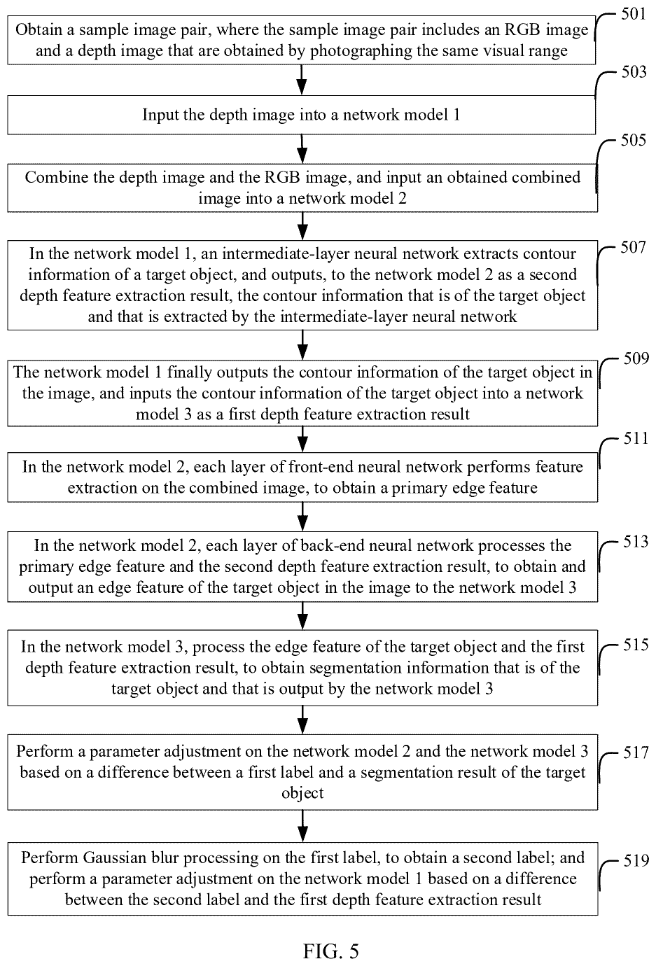

With reference to a specific embodiment, the following describes in detail the process shown in FIG. 2 by using Manner 2 as an example. As shown in FIG. 4A, FIG. 4B, and FIG. 5, the following steps are specifically included. Step 501: Obtain a sample image pair, where the sample image pair includes an RGB image and a depth image that are obtained by photographing the same visual range.

Usually, an RGB photographing apparatus and a depth image photographing apparatus are installed at the same location, so that images in the same visual range can be photographed. For example, the RGB photographing apparatus and the depth image photographing apparatus are both installed in a POS machine. A facial recognition payment scenario is used as an example. A person who is to pay currently is photographed at approximately the same location through the RGB image photographing apparatus and the depth image photographing apparatus, to obtain an RGB image and a depth image. Both the RGB image and the depth image include information about a portrait, and are likely to include information about a plurality of portraits.

Step 503: Input the depth image into a network model 1.

A function of the network model 1 is to extract depth structure information from the depth image, namely, approximate contour information of a target object. A structure of the network model 1 can be a multi-layer convolutional neural network.

The network model 1 can include MobileNetV2. In the network model 1, MobileNetV2 extracts a depth data feature (for example, a depth face data feature) of each object in an image, and then performs a deconvolution operation to sample a convolution result to a size of ¼ of the input depth image.

Step 505: Combine the depth image and the RGB image, and input an obtained combined image into a network model 2.

A function of the network model 2 is to complement, based on information about the RGB image, edge detail information in the contour information that is of the target object and that is obtained based on the depth image, so that a contour that is of the target object and that is obtained through segmentation is clearer and more accurate. A structure of the network model 2 can be a multi-layer convolutional neural network.

In step 505, the combined image is actually generated after the depth image and the RGB image are stitched together. For example, an original RGB image includes 3 channels, and the depth image is stitched on the 4th channel, to obtain the combined image.

In addition, in step 505, for ease of processing, a pixel value of the RGB image and a pixel value of the depth image can be normalized first, for example, normalized to a value in 0 to 1. For the depth image, a pixel value of a pixel whose value is null in the depth image is normalized to 0.

Step 507: In the network model 1, an intermediate-layer neural network extracts contour information of the target object, and outputs, to the network model 2 as a second depth feature extraction result, the contour information that is of the target object and that is extracted by the intermediate-layer neural network.

Step 509: The network model 1 finally outputs the contour information of the target object in the image, and inputs the contour information of the target object into a network model 3 as a first depth feature extraction result.

Step 511: In the network model 2, each layer of front-end neural network performs feature extraction on the combined image, to obtain a primary edge feature.

Step 513: In the network model 2, each layer of back-end neural network processes the primary edge feature and the received second depth feature extraction result, to obtain and output the edge feature of the target object in the image to the network model 3.

In step 513, because an intermediate processing result (namely, the second depth feature extraction result) of the network model 1 and an intermediate processing result (namely, the primary edge feature) of the network model 2 need to be used together as an input into each layer of back-end neural network in the network model 2, the two intermediate processing results need to have the same size, namely, the same image size. In this embodiment of this specification, convolution kernels and convolution strides of the network model 1 and the network model 2 can be adjusted, so that the two intermediate processing results (the primary edge feature and the second depth feature extraction result) correspond to the same image size.

It should be noted that, if training of the segmentation model is implemented in Manner 1, in step 513, in the network model 2, each layer of back-end neural network processes the primary edge feature (the second depth feature extraction result is no longer used), to obtain and output the edge feature of the target object in the image to the network model 3.

Step 515: In the network model 3, process the edge feature of the target object in the input image and the first depth feature extraction result, to obtain and output segmentation information of the target object.

Step 517: Perform a parameter adjustment on the network model 2 and the network model 3 based on a difference between a first label and a segmentation result of the target object.

In step 517, the first label is segmentation information that is of the target object in the RGB image or the depth image and that is formed manually in advance. Therefore, parameters of the network model 2 and the network model 3 can be adjusted simultaneously based on a difference between the first label and segmentation information that is of the target object and that is output by the network model 3, to optimize the segmentation model.

Step 519: Perform Gaussian blur processing on the first label, to obtain a second label; and perform a parameter adjustment on the network model 1 based on a difference between the second label and the first depth feature extraction result.

As shown in FIG. 3A and FIG. 4A, a deconvolution operation can be first performed on the first depth feature extraction result output by the network model 1, and then, the parameter adjustment is performed on the network model 1 based on a difference between a result of the deconvolution operation and the second label.

Referring to step 503, because a final output of the network model 1 is usually a size of ¼ of the input image (the convolution result is sampled to the size of ¼ of the input depth image in step 503), in this step 519, the first label can be reduced to ¼ of an original size, and then Gaussian blur processing is performed, to obtain the second label.

In step 519, the second label is generated based on a manual label, namely, the first label. Therefore, a parameter of the network model 1 can be adjusted based on the difference between the second label and the first depth feature extraction result output by the network model 1, to optimize the network model 1, so that in a subsequent training process, the optimized network model 1 can be used to continue training the segmentation model.

In this embodiment of this specification, a training process of step 501 to step 519 can be performed for a plurality of times based on a plurality of groups of sample images, until the segmentation model converges.

It can be seen from the above-mentioned process shown in FIG. 5 that, in this embodiment of this specification, not only an original depth image is used at an initial stage of the training process (that is, the depth image and the RGB image are combined, to train the segmentation model based on the combined image), but also a processing result of the depth image is used for two times at a subsequent stage of the training process (that is, the segmentation model is trained based on a depth feature extraction result). That is, the combined image and the depth feature extraction result are used together to train the segmentation model. It can be seen that depth information provided by the depth image is separately used at different stages of the training process, so that the trained segmentation model can more accurately obtain the segmentation information of the target object in the image.

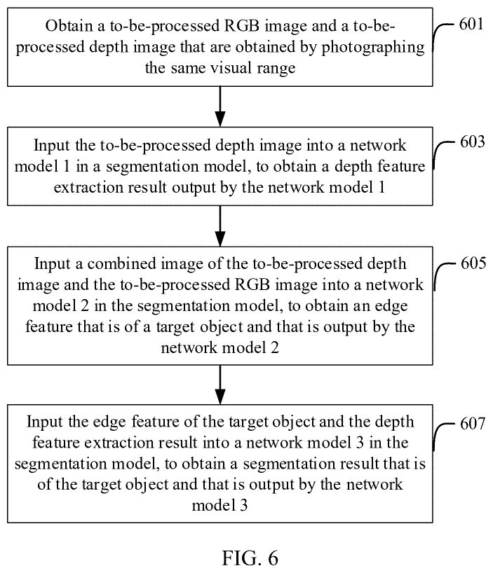

Image recognition can be performed through the segmentation model trained in the method in any embodiment of this specification. As shown in FIG. 6, in an embodiment of this specification, an image recognition method includes: Step 601: Obtain a to-be-processed RGB image and a to-be-processed depth image that are obtained by photographing the same visual range.

Step 603: Input the to-be-processed depth image into a network model 1 in a segmentation model, to obtain a depth feature extraction result output by the network model 1.

Step 605: Input a combined image of the to-be-processed depth image and the to-be-processed RGB image into a network model 2 in the segmentation model, to obtain an edge feature that is of a target object and that is output by the network model 2.

Step 607: Input the edge feature of the target object and the depth feature extraction result into a network model 3 in the segmentation model, to obtain a segmentation result that is of the target object and that is output by the network model 3.

After the segmentation information of the target object is obtained from the image in the method shown in FIG. 6 (for example, information about a portrait of a person who is to pay currently or information about a product to be paid for currently), subsequent service processing can be performed based on the segmentation information of the target object. For example, because information about a target portrait is obtained through segmentation from a plurality of portraits, live detection and facial recognition payment can be performed for a face of the target portrait in a targeted manner. In this manner, a problem that a face of a person who does not want the face to be scanned in a facial recognition process appears on a screen can be avoided, and a problem that a feeling of privacy insecurity is caused when a person who queues appears on the screen can be resolved, so that a whole procedure is more friendly to privacy of a user.

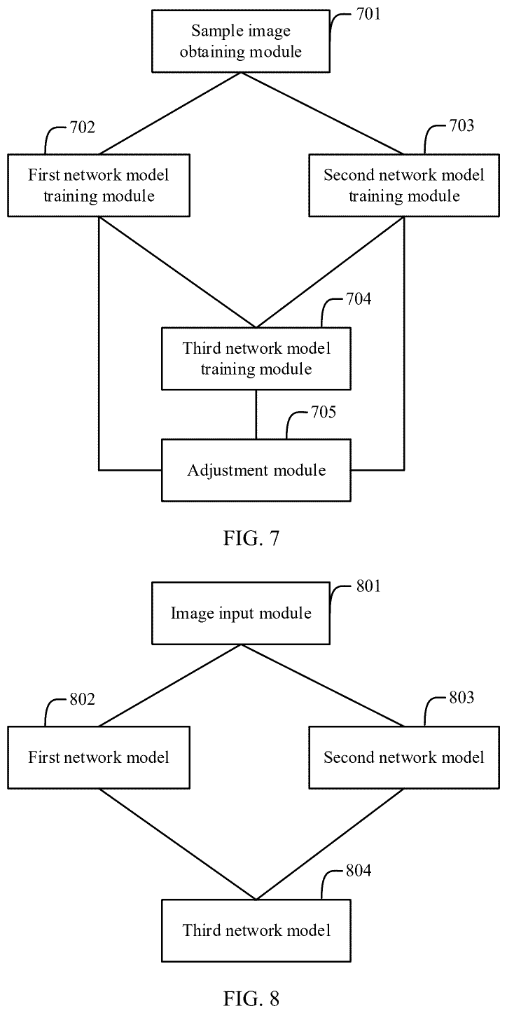

In an embodiment of this specification, a segmentation model training apparatus is provided. As shown in FIG. 7, the apparatus includes: a sample image obtaining module 701, configured to obtain a sample image pair, where the sample image pair includes an RGB image and a depth image that are obtained by photographing the same visual range; a first network model training module 702, configured to input the depth image into a first network model, to obtain a first depth feature extraction result output by the first network model; a second network model training module 703, configured to: combine the depth image and the RGB image, and input the combined image into a second network model, to obtain an edge feature that is of a target object and that is output by the second network model; a third network model training module 704, configured to input the edge feature of the target object and the first depth feature extraction result into a third network model, to obtain a segmentation result that is of the target object and that is output by the third network model; and an adjustment module 705, configured to perform a parameter adjustment on the first network model, the second network model, and the third network model based on a label of the sample image pair and the segmentation result of the target object.

In an embodiment of the training apparatus in this specification shown in FIG. 7, the label of the sample image pair includes a first label and a second label, the first label is a segmentation result that is of the RGB image or the depth image and that is formed manually in advance, and the second label is obtained after Gaussian blur processing is performed on the first label. The adjustment module 705 is configured to: perform a parameter adjustment on the second network model and the third network model based on a difference between the first label and the segmentation result of the target object; and perform a parameter adjustment on the first network model based on a difference between the second label and the first depth feature extraction result.

In an embodiment of the training apparatus in this specification shown in FIG. 7, the first network model training module 702 is further configured to: obtain contour information that is of the target object and that is extracted by an intermediate-layer neural network included in the first network model, and output, to the second network model as a second depth feature extraction result, the contour information that is of the target object and that is extracted by the intermediate-layer neural network; and the second network model training module 703 is further configured to: control each layer of front-end neural network included in the second network model to perform feature extraction on the combined image, to obtain a primary edge feature; and control each layer of back-end neural network included in the second network model to process the primary edge feature and the second depth feature extraction result, so that the second network model outputs the edge feature of the target object.

In an embodiment of the training apparatus in this specification shown in FIG. 7, the adjustment module 705 is configured to adjust convolution kernels and convolution strides of the first network model and the second network model, so that the primary edge feature and the second depth feature extraction result correspond to the same image size.

In an embodiment of the training apparatus shown in FIG. 7, the second network model training module 703 is further configured to: before the depth image and the RGB image are combined, normalize a pixel value of the RGB image and a pixel value of the depth image, and normalize, to 0, a pixel value of a pixel whose value is null in the depth image.

In an embodiment of this specification, an image recognition apparatus is provided. As shown in FIG. 8, the apparatus includes: an image input module 801, configured to obtain a to-be-processed RGB image and a to-be-processed depth image that are obtained by photographing the same visual range; a first network model 802, configured to receive the to-be-processed depth image, to obtain a depth feature extraction result; a second network model 803, configured to receive a combined image of the to-be-processed depth image and the to-be-processed RGB image, to obtain an edge feature of a target object; and a third network model 804, configured to receive the edge feature of the target object and the depth feature extraction result, to obtain a segmentation result of the target object.

An embodiment of this specification provides a computer-readable storage medium. The computer-readable storage medium stores a computer program, and when the computer program is executed on a computer, the computer is enabled to perform the method according to any embodiment of this specification.

An embodiment of this specification provides a computing device, including a memory and a processor. The memory stores executable code, and when the processor executes the executable code, the method in any embodiment of this specification is performed.

It can be understood that a structure shown in the embodiments of this specification does not constitute a specific limitation on the apparatus in the embodiments of this specification. In some other embodiments of this specification, the above-mentioned apparatus may include more or fewer components than those shown in the figure, or combine some components, or split some components, or have different component arrangements. The components in the figure can be implemented by hardware, software, or a combination of software and hardware.

Content such as information exchange and an execution process between the modules in the apparatus and the system is based on the same idea as the method embodiments of this specification. Therefore, for detailed content, references can be made to descriptions in the method embodiments of this specification. Details are not described herein again.

The embodiments of this specification are described in a progressive way. For same or similar parts of the embodiments, mutual references can be made to the embodiments. Each embodiment focuses on a difference from other embodiments. Particularly, the apparatus embodiments are briefly described because they are basically similar to the method embodiments. For related parts, references can be made to related descriptions in the method embodiments.

A person skilled in the art should be aware that in the above-mentioned one or more examples, functions described in the present disclosure can be implemented by hardware, software, firmware, or any combination thereof. When the functions are implemented by software, the above-mentioned functions can be stored in a computer-readable medium or transmitted as one or more instructions or code in the computer-readable medium.

In the above-mentioned specific implementations, the objectives, technical solutions, and beneficial effects of the present disclosure are further described in detail. It should be understood that the above-mentioned descriptions are merely specific implementations of the present disclosure, but are not intended to limit the protection scope of the present disclosure. Any modification, equivalent replacement, improvement, etc. made based on the technical solutions of the present disclosure shall fall within the protection scope of the present disclosure.

1. A segmentation model training method, wherein the segmentation model comprises a first network model, a second network model, and a third network model, and the method comprises:
obtaining a sample image pair, wherein the sample image pair comprises an RGB image and a depth image that are obtained by photographing the same visual range;
inputting the depth image into the first network model, to obtain a first depth feature extraction result output by the first network model;
inputting a combined image of the depth image and the RGB image into the second network model, to obtain an edge feature that is of a target object and that is output by the second network model;
inputting the edge feature of the target object and the first depth feature extraction result into the third network model, to obtain a segmentation result that is of the target object and that is output by the third network model; and
performing a parameter adjustment on the first network model, the second network model, and the third network model based on a label of the sample image pair and the segmentation result of the target object.

2. The method according to claim 1, wherein
the label of the sample image pair comprises a first label and a second label, the first label is a segmentation result that is of the RGB image or the depth image and that is formed manually in advance, and the second label is obtained after Gaussian blur processing is performed on the first label; and
the performing a parameter adjustment on the first network model, the second network model, and the third network model comprises:
performing a parameter adjustment on the second network model and the third network model based on a difference between the first label and the segmentation result of the target object; and
performing a parameter adjustment on the first network model based on a difference between the second label and the first depth feature extraction result.

3. The method according to claim 1, wherein
after the inputting the depth image into the first network model, the method further comprises: obtaining contour information that is of the target object and that is extracted by an intermediate-layer neural network comprised in the first network model, and outputting, to the second network model as a second depth feature extraction result, the contour information that is of the target object and that is extracted by the intermediate-layer neural network; and
after the inputting a combined image of the depth image and the RGB image into the second network model, and before the edge feature that is of the target object and that is output by the second network model is obtained, the method further comprises:
performing feature extraction on the combined image through each layer of front-end neural network comprised in the second network model, to obtain a primary edge feature; and
processing the primary edge feature and the second depth feature extraction result though each layer of back-end neural network comprised in the second network model, to obtain and output the edge feature of the target object.

4. The method according to claim 3, wherein convolution kernels and convolution strides of the first network model and the second network model are adjusted, so that the primary edge feature and the second depth feature extraction result correspond to the same image size.

5. The method according to claim 1, wherein before the depth image and the RGB image are combined, the method further comprises:
normalizing a pixel value of the RGB image and a pixel value of the depth image, and normalizing, to 0, a pixel value of a pixel whose value is null in the depth image.

6. An image recognition method, comprising:
obtaining a to-be-processed RGB image and a to-be-processed depth image that are obtained by photographing the same visual range;
inputting the to-be-processed depth image into a first network model, to obtain a depth feature extraction result output by the first network model;
inputting a combined image of the to-be-processed depth image and the to-be-processed RGB image into a second network model, to obtain an edge feature that is of a target object and that is output by the second network model; and
inputting the edge feature of the target object and the depth feature extraction result into a third network model, to obtain a segmentation result that is of the target object and that is output by the third network model.

7-9. (canceled)

10. A computing device, comprising a memory and a processor, wherein the memory stores executable code, and when the processor executes the executable code, the processor is caused to implement a segmentation model training method, wherein the segmentation model comprises a first network model, a second network model, and a third network model, the method comprising:
obtaining a sample image pair, wherein the sample image pair comprises an RGB image and a depth image that are obtained by photographing the same visual range;
inputting the depth image into the first network model, to obtain a first depth feature extraction result output by the first network model;
inputting a combined image of the depth image and the RGB image into the second network model, to obtain an edge feature that is of a target object and that is output by the second network model;
inputting the edge feature of the target object and the first depth feature extraction result into the third network model, to obtain a segmentation result that is of the target object and that is output by the third network model; and
performing a parameter adjustment on the first network model, the second network model, and the third network model based on a label of the sample image pair and the segmentation result of the target object.

11. The computing device according to claim 10, wherein
the label of the sample image pair comprises a first label and a second label, the first label is a segmentation result that is of the RGB image or the depth image and that is formed manually in advance, and the second label is obtained after Gaussian blur processing is performed on the first label; and
the performing a parameter adjustment on the first network model, the second network model, and the third network model comprises:
performing a parameter adjustment on the second network model and the third network model based on a difference between the first label and the segmentation result of the target object; and
performing a parameter adjustment on the first network model based on a difference between the second label and the first depth feature extraction result.

12. The computing device according to claim 10, wherein
after the inputting the depth image into the first network model, the method further comprises: obtaining contour information that is of the target object and that is extracted by an intermediate-layer neural network comprised in the first network model, and outputting, to the second network model as a second depth feature extraction result, the contour information that is of the target object and that is extracted by the intermediate-layer neural network; and
after the inputting a combined image of the depth image and the RGB image into the second network model, and before the edge feature that is of the target object and that is output by the second network model is obtained, the method further comprises:
performing feature extraction on the combined image through each layer of front-end neural network comprised in the second network model, to obtain a primary edge feature; and
processing the primary edge feature and the second depth feature extraction result though each layer of back-end neural network comprised in the second network model, to obtain and output the edge feature of the target object.

13. The computing device according to claim 12, wherein convolution kernels and convolution strides of the first network model and the second network model are adjusted, so that the primary edge feature and the second depth feature extraction result correspond to the same image size.

14. The computing device according to claim 10, wherein before the depth image and the RGB image are combined, the method further comprises:
normalizing a pixel value of the RGB image and a pixel value of the depth image, and normalizing, to 0, a pixel value of a pixel whose value is null in the depth image.

15. The computing device according to claim 10, wherein the processor is further caused to implement an image recognition method, the method comprising:
obtaining a to-be-processed RGB image and a to-be-processed depth image that are obtained by photographing the same visual range;
inputting the to-be-processed depth image into a first network model, to obtain a depth feature extraction result output by the first network model;
inputting a combined image of the to-be-processed depth image and the to-be-processed RGB image into a second network model, to obtain an edge feature that is of a target object and that is output by the second network model; and
inputting the edge feature of the target object and the depth feature extraction result into a third network model, to obtain a segmentation result that is of the target object and that is output by the third network model.
